(19) United States
(12) Patent Application Publication
(10) Pub. No.: US 2006/0219708 A1
(43) Pub. Date: Oct. 5, 2006

(54) Multi-Panel Reconfigurable Dry Erase Board

(76) Inventor: Kevin Haglund, Peachtree City, GA (US)

Correspondence Address: MERCHANT & GOULD PC, P.O. BOX 2903, MINNEAPOLIS, MN, 55402-0903, US

(21) Appl. No.: 11/277,059

(22) Filed: Mar. 21, 2006

Related U.S. Application Data
(60) Provisional application No. 60/663,805, filed on Mar. 21, 2005.

(51) Int. Cl. H05B 6/10

(52) U.S. Cl. 219/633

(57) ABSTRACT

A group of flexible dry erase panels are positioned along a set of rails (free-standing, wall-mounted, etc.), creating a multi-panel dry erase board. Panels can be repositioned along the rails, so as to accomplish rearranging of the panels. Panels can be slid along the set of rails or can be flexed to remove or reinsert into the rails. Rearranging dry erase panels can be useful for organizing items, such as weekly schedules, projects, and so forth.

### RELATED APPLICATIONS

This patent application claims priority to the U.S. Provisional Patent Application entitled, “Multi-Panel General Purpose Reconfigurable Dry Erase Board,” filed on Mar. 21, 2005 and having Ser. No. 60/663,805.

### BACKGROUND

Conventional dry erase boards have provided only a single unitary dry erase panel, which is not suitable for compartmentalizing and tracking information. In an effort to compartmentalize information, one typically must resort to creating a grid using a marker or tape to divide the panel into different sections or quadrants. In an effort to track information, one must constantly erase information from one section and rewrite the same information in another section or be forced to mentally rearrange the information into its logical or sequential order on a regular basis. Regularly erasing and rewriting the same information can take considerable time. Regularly attempting to rearrange the information in one's mind can be confusing and challenging, particularly given that the logical order may vary from day to day or week to week.

For example, assume a dry erase board is being used to plan a month of worship services and the panel has been divided into four sections using a marker or tape. Beginning on the left, there is a first section for the service on the first Sunday of the month, followed by a second section for the service on the second Sunday of the month, and so on. During the second week of the month, one would erase each of the four panels and rewrite the services for the second Sunday in the first section, the services for the third Sunday in the second section, and so on. Alternatively, one would leave the sections as is, such that the first section would continue to reflect the services for the first Sunday even though it is the second week of the month. During the third week of the month, one would erase each of the four panels again and rewrite the services for the third Sunday in the first section, the services for the fourth Sunday in the second section, and so on. Again, the other option would be to leave the sections as is, such that the first section would continue to reflect the services for the first Sunday even thought it is the third week of the month.

The standard size and shape of conventional dry erase boards are also not suitable for compartmentalizing and tracking information. Dry erase boards are typically sold as 3′ by 5′, 4 ′ by 8′ or 8½″ by 11″—none of which are particularly suitable for building and tracking a list of items.

### SUMMARY

A multi-panel dry erase board is comprised of a multitude of rails, between which are placed a multitude of flexible dry erase panels. Panels can be removed, inserted and rearranged along the rails. A method for rearranging panels on a multi-panel dry erase board is comprised of removing a first dry erase panel from a set of rails by flexing the panel, repositioning a second panel into the location of the first panel, and adding the first dry erase panel back to the rails in a second location.

### BRIEF DESCRIPTION OF THE DRAWINGS

The foregoing brief summary of the invention, as well as the following detailed description, is better understood when read in conjunction with the accompanying drawings, which are included by way of example, and not by way of limitation with regard to the claimed invention. In the accompanying drawings, the same or similar elements are labeled with the same reference numbers, and wherein:

FIG. 1 is a front view of an embodiment of a multi-panel dry erase board including two rails;

FIG. 2 is a front view of an embodiment of a multi-panel dry erase board including three rails;

FIG. 3 is a perspective view of an embodiment of a rail for use with a multi-panel dry erase board;

FIG. 4 is a front view of an embodiment of a panel and two edge moldings for use with a multi-panel dry erase board;

FIG. 5 is a side or end view of an embodiment of a panel and two edge moldings for use with a multi-panel dry erase board; and

FIGS. 6A-6E depict a method for rearranging the panels of a multi-panel dry erase board.

### DETAILED DESCRIPTION

By dividing white boards into moveable panels that can be rearranged relative to each other, information of any kind, such as project or work schedule information, can be compartmentalized into separate dry erase panels and easily moved or arranged into a logical or sequential order. The need to erase information from one portion of a dry erase board and rewrite it to another portion of the board is eliminated. The confusing task of mentally rearranging out-of-order information of any kind is eliminated, because white board panels can be rearranged on the fly.

Furthermore, by dividing white boards into moveable sections, information of any kind can be compartmentalized into separate dry erase panels that are adapted so as to be easily moved between different sets of rails. White board panels need not have a fixed connection to other panels, allowing flexible rearrangement of compartmentalized information. Moreover, the use of inexpensive lattice moldings as rails may provide cost savings over conventional metal rails.

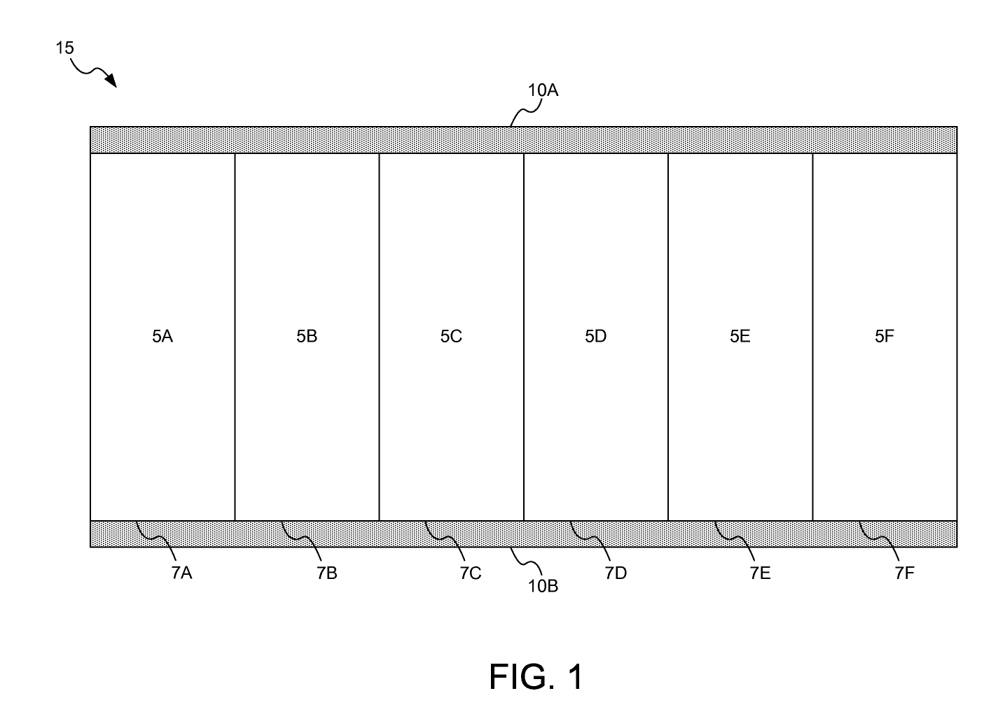

Referring to FIG. 1, an exemplary multi-panel dry erase board 15 is shown. The board 15 includes six dry erase panels 5A-5F and two rails 10A-10B. Each panel 5 is connected to an upper rail 10A and a lower rail 10B. Each panel 5 contacts one or more adjacent panels 5, such that the panels together form a multi-panel dry erase board. There is no attachment between the panels 5. Each panel 5 is capable of being separately moved or slid along or within the rails 10 or out of the rails 10. Each panel 5 thus can be separately moved from one rail location 7 to another. Panel 5A is currently shown in rail position 7A; panel 5B is currently shown in rail position 7B; and so on for panels 5C-5F. If the information on panel 5A becomes outdated, panel 5A can be removed from the rails by bending the panel 5A and popping it out of the rails or sliding the panel 5A out of the rails. Panels 5B-5F can then each be slid one rail position to the left, putting panel 5B into rail position 7A. The removed panel 5A can be erased and reinserted into the rails 10 at rail position 7F for example.

Using the dry erase board 15, information of any kind can be compartmentalized or segmented among panels 5A-5F, allowing each panel 5 to be used individually. By moving panels 5A-5F among the rail locations 7A-7F, the dry erase board 15 can be reconfigured such that information can be maintained in a logical or sequential order. For example, assume dry erase board 15 is being used for planning six weeks of worship services where each panel contains the worship service for a particular week. By moving the panels on a weekly basis, the most current panel 5 can be kept in rail position 7A. For example, assume panel 5A includes the service for the first week; panel 5B includes the service for the second week; and so on. Once the first week is past, panel 5A can be removed from the rails 10, and panel 5B can be slid or moved into rail position 7A. Each panel 5 is of suitable flexibility to be easily removed from the rails 10. Because the rails 10 are open at their ends or sides, an end panel 5 can be easily slid out. The connection between each panel 5 and the rails 7 should be suitably firm or steady to allow one to write on the panels 5 without the panels 5 moving horizontally. As such, there should be a reasonable amount of effort or force required to move the panel 5 from one rail position 7 to another. While sliding may be the simplest means of moving a panel 5, the panel can alternatively be moved through other means such as a rolling mechanism with a locking feature for example. Aside from moving the panels 5 to different positions within one rail system, the panels 5 can instead be moved to a different rail system. For example, the panel 5 can be removed from rails 10 located in an office and added to a set of rails located in a conference room.

The panel 5 may be a non-magnetic or a magnetic surface. An example of a suitable non-magnetic surface is a melamine dry erase panel available from AFCO of Holland, Mich. Its website is www.AFCO-ind.com. The panels 5A-5F can vary in size and shape depending on the particular application. One factor could be the distance between the dry erase board 15 and a person's desk to allow a person to read the board 15 from the desk. Another factor could be the amount of wall space in the room containing the dry erase board 15. Yet another factor is the number of panels 5 desired. The panel 5 can be cut to a desired size by any suitable means such as a table saw for example. As an example of a possible configuration, each panel 5 can be sixteen inches in width. In this way, each panel would be relatively thin and long to allow for writing a list of items on each panel. If there is an interest in tracking only four weeks of information, the dry erase board 15 could instead be divided into four panels where each panel is twenty-four inches in width. Similarly, if there is an interest in tracking eight weeks of information, the dry erase board 15 could be divided into eight separate panels where each panel is a foot in length for example. The number of panels may only be limited by the physical limitations of the dry erase board material, and the imagination of the designer. In addition to tracking weekly information, as provided in the above example, panels may be used to track monthly or daily information, and can be divided for items other than increments of time. For example, panels can be used to track projects, employees, assets, or any other type of item. If there is a desire to print the information contained on a particular panel 5 or set of panels 5, then the panels may be electronically connected in a serial or parallel fashion to a computer or computing device with a printer connection.

The rails 10 can be implemented in a number of ways. An example of a suitable rail 10 is the TUFF-BILT lattice divider molding available from U.S. Fence. Its website is www.tuffbilt.com. The molding is 2 and ⅛″ in width, 97″ in length and ¾″ in thickness. Such a molding is typically used to adjoin vinyl lattice material. A picture and description of the molding can be found at www.usfenceonline.com/tuffbilt/lattice/lattac.html. The rails 10 can be adapted so that the dry erase board 15 can be portable or wall mounted. To allow for wall mounting, holes can be drilled into the rails 10A-10B for use with wall anchors and/or screws. Standard hollow wall anchors and screws can be obtained from a number of companies such as Crown Bolt, Inc. of Aliso Viejo, Calif. for example. Its website is www.crownbolt.com. To allow for anchoring the rails 10A-10B into studs, the holes can be drilled sixteen inches apart. The dry erase board 15 can be made portable by affixing the rails 10A-10B to a rolling stand. In place of a long rail, each rail 10 can be replaced with multiple rails of smaller size for ease of transport.

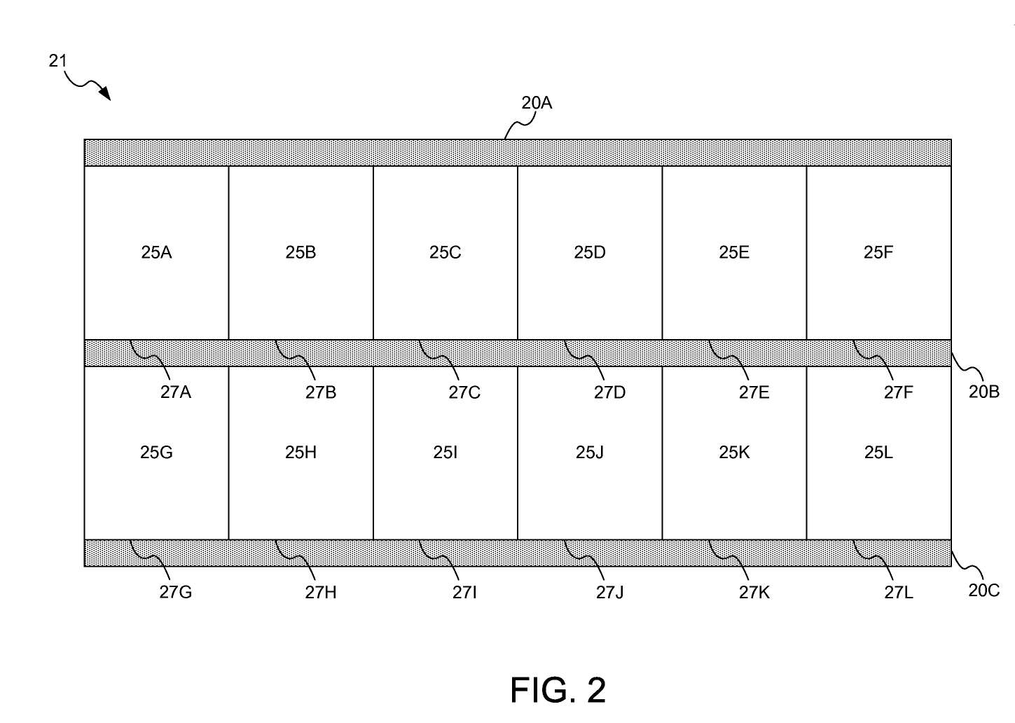

Referring to FIG. 2, a multi-panel dry erase board 21 including three rails is shown. The board 21 includes rails 20A-20C and twelve dry erase panels 25A-25L. Each rail 20 can be implemented as an eight-foot rail for example. Each panel 25 can be implemented as a 24″×16″ panel for example. Dry erase board 21 allows for more compartmentalization than dry erase board 15 of FIG. 1. While dry erase board 15 includes six panels, dry erase board 21 includes twelve panels. Each panel 25 can be moved in a similar fashion as described with respect to panel 5 in FIG. 1. Panels 25A-25L are shown in rail positions 27A-27L respectively. When the information in panel 25A becomes outdated, panel 25A can be removed from rails 20A-20B. Panel 25B can then be slid to the left into rail position 27A; panel 25C can be slid into rail position 27B; panel 25G can be removed from rail position 27G and placed into rail position 27F; and so on. Panel 25A can then be erased and inserted between rails 20B-20C in rail position 27L. While in this example, a panel 25 is inserted into rails 20 at an end rail location such as 27L or 27F, a panel 25 can just easily be inserted in other rail positions such as 27C or 27J.

Referring to FIG. 3, a perspective view of an exemplary rail 10 or 20 is shown. The rail 10 or 20 can be implemented as the lattice molding described above. As shown, the rail 10 or 20 forms an upper groove 33A and a lower groove 33B. Alternatively, the rail 10 or 20 could form a single groove or more than two grooves. This groove, tract or slot allows for a moveable and firm connection of the rail 10 or 20 to the panel 5 or 25. The configuration of the panel 10 of 20 can vary. For example, while FIG. 3 shows an H-style side configuration, a U-style side configuration might be used alternatively. One advantage of the H-style side configuration is the ease of mounting with screws. While the dimensions of the rail 10 of 20 can vary depending on the particular application, the following dimensions are suitable for certain applications: the length 37 is around 96 or 97 inches; the height 30 is around 2⅛ inches; the width 35 is around 3/4 inches; and the groove 33 is around 1/8 inch.

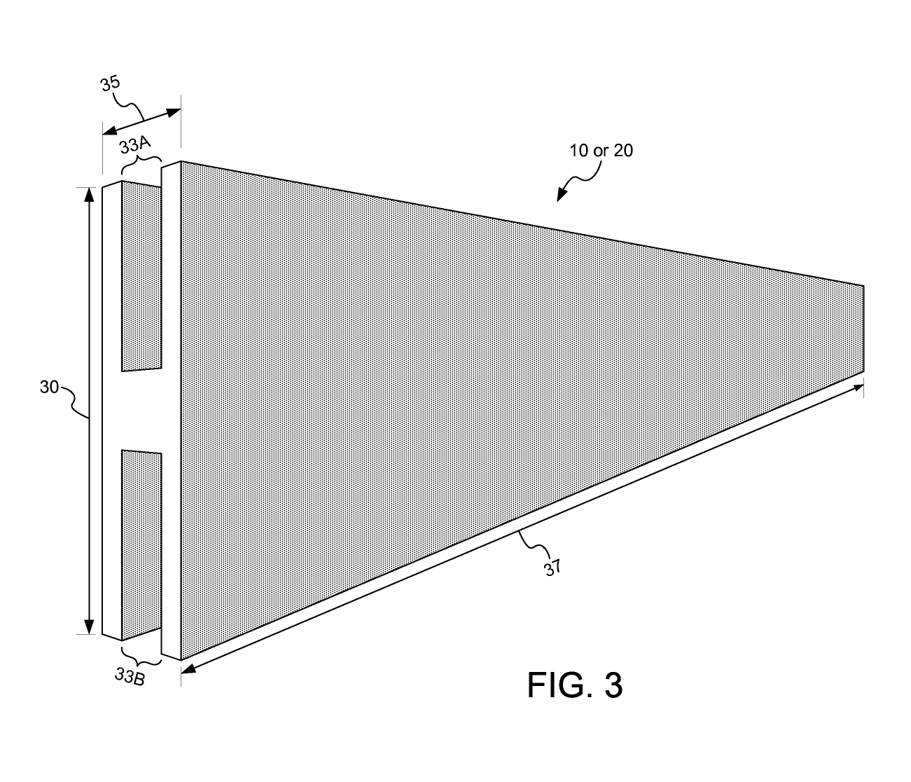

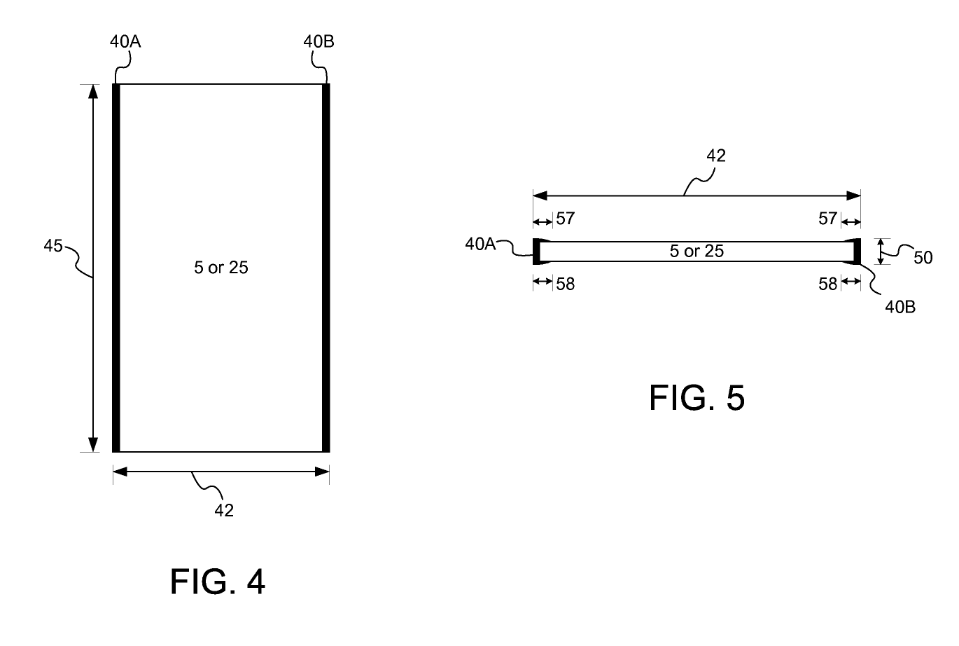

Referring to FIG. 4, the panel 5 or 25 is shown with edge moldings or trims 40. Edge molding 40A is shown on the left side of the panel 5 or 25, and edge molding 40B is shown on the right side of the panel 5 or 25. One advantage of edge moldings 40A and 40B is that they protect the panel 5 or 25 from chipping. The edge moldings 40 can be cut to a desired size for fitting the panel 5 or 25 using a suitable cutting means such as heavy duty scissors for example. For the exemplary panel 5 or 25 in FIG. 4, the height 45 is 48″ and the length 50 is 16″. An example of a suitable edge molding is an end cap molding available from Glasstel-www.glassteel.com.

Referring to FIG. 5, a side or end view of the panel 5 or 25 and edge moldings 40A-40B is shown. The desired thickness 50 of the edge moldings 40 can depend upon the size of the groove 33. If the groove 33 is around ⅛″ in width, then the edge molding thickness 60 can be around the same. For FIG. 5, the top of panel 5 or 25 shown is assumed to be the front of the panel, and the bottom of the panel 5 or 25 is assumed to be the back of the panel. While the front overhang 57 of the edge trimming 40 appears to be the same size as the back overhang 58 of the edge molding 40, it should be understood that the overhang between the front and back portions of the edge molding 40 can vary. It should be noted that other styles of edge moldings may be utilized. For example, overhangs 57 and 58 may have a square, rounded, or other shape applied to them.

When a multi-panel reconfigurable dry-erase board includes more than three panels, sliding the panels to rearrange the panels can get tedious, especially if one panel in the center needs to be placed at an end. Multiple panels would have to slide out of the rails in order to remove the center panel, and then be replaced. Having flexible dry-erase panels allows a panel to be flexed and popped out of the rails in place, avoiding the removal of additional panels. Remaining panels can be slid, and the center panel added to the end.

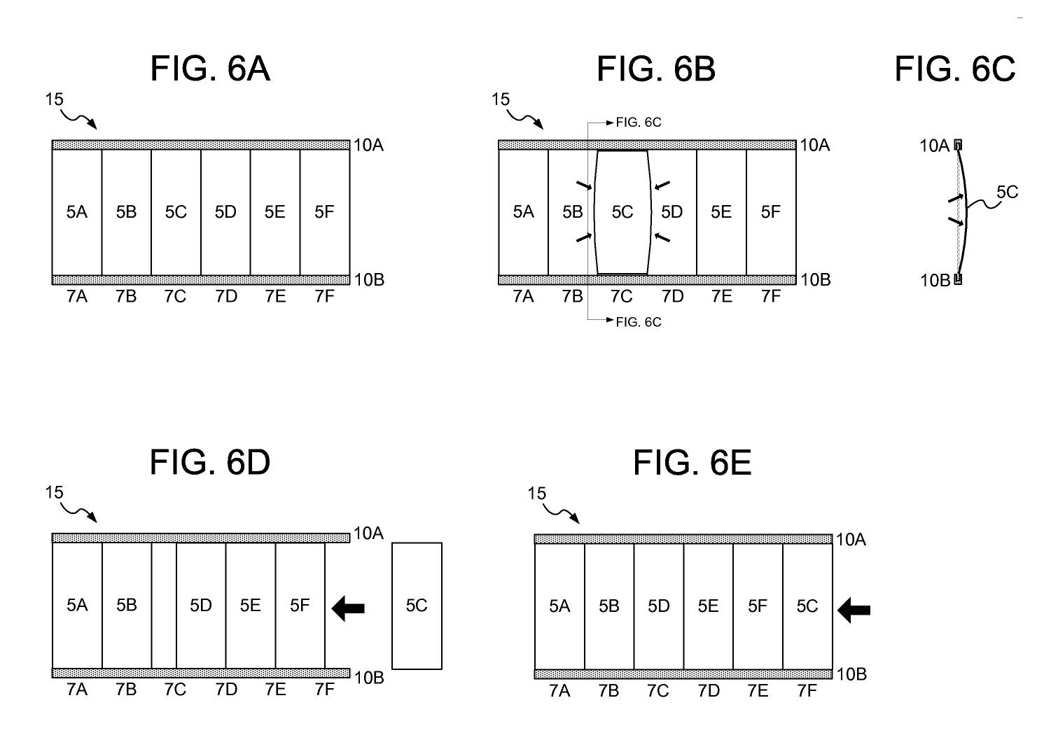

This is depicted in the example of FIGS. 6A-6F which depict a method for modifying a multi-panel dry erase board 15 is shown. FIG. 6A shows multi-panel dry erase board 15, having rails 10A and 10B, and panels 5A-5F, located respectively in positions 7A-7F. In FIG. 6B, panel 5C is removed from board 15 by flexing panel 5C and popping it out of rails 10. FIG. 6C gives a side view of flexing panel 5C out of rails 10. Flexing the panel may be accomplished by pushing on the panels on either side (e.g., 5B and 5D) and placing an apparatus (e.g., fingers) behind board 5C and pulling out. Other methods for flexing and removing panel 5C may be utilized.

In FIG. 6D, panels 5D-5F are slid along rails 10 over to the left to fill the space left by panel 5C. Alternatively, these panels may be moved in any other fashion, such as by individually removing and reinserting each panel. Now, panel 5D is in location 7C, 5E in location 7D, and so forth. In FIG. 6E, panel 5C is reinserted into empty location 7F. Reinsertion of panel 5C may be accomplished by sliding into place, or by flexing and reinserting into the rails. The result of the method is that panels 5A-5F are rearranged within their locations 7A-7F. It should be noted that depending on the size and configuration of the multi-panel dry erase board and panels, other methods for rearranging the panels may be available.

While apparatuses and methods embodying the present invention are shown by way of example, it will be understood that the invention is not limited to these embodiments. The methods and systems described are merely examples of the invention, the limits of which are set forth in the claims which follow. Those skilled in the art may make modifications and yet remain within the scope of the claims, particularly in light of the foregoing teachings.

We claim:

1. A multi-panel dry erase board comprising:
a plurality of rails; and
a plurality of flexible dry erase panels moveably and firmly connected to the plurality of rails.

2. The multi-panel dry erase board of claim 1, wherein the plurality of rails comprises a first rail and a second rail, and the plurality of flexible dry erase panels comprises a first panel, a second panel, and a third panel, and wherein the first, second, and third panels are capable of sliding along the plurality of rails.

3. The multi-panel dry erase board of claim 1, wherein the plurality of flexible dry erase panels are adapted to slide along the plurality of rails.

4. The multi-panel dry erase board of claim 1, wherein the plurality of flexible dry erase panels are adapted to flex for removal from and insertion into the plurality of rails.

5. The multi-panel dry erase board of claim 1, wherein the plurality of flexible dry erase panels are adapted to move any panel from one location with respect to the plurality of rails to another location.

6. The multi-panel dry erase board of claim 1, further comprising:
means for moving any panel of the plurality of flexible dry erase panels from one location with respect to the plurality of rails to another location.

7. The multi-panel dry erase board of claim 1, wherein the plurality of flexible dry erase panels are non-magnetic.

8. The multi-panel dry erase board of claim 1, wherein the plurality of flexible dry erase panels are relatively long and thin.

9. The multi-panel dry erase board of claim 1, wherein the plurality of rails comprises a first rail, a second rail, and a third rail, and wherein the plurality of flexible dry erase panels comprise a first number of dry erase panels, each connected to both the first and second rails, and a second number of dry erase panels, each connected to both the second and third rails.

10. The multi-panel dry erase board of claim 1, wherein the plurality of rails comprises a plurality of lattice moldings.

11. The multi-panel dry erase board of claim 1, wherein the multi-panel dry erase board is for planning worship services, and wherein the plurality or dry erase panels are relatively long and thin.

12. A multi-panel dry erase board, comprising:
a first rail and a second rail, wherein the first and second rails are comprised of lattice moldings; and
a first plurality of flexible dry erase panels, wherein the first plurality of flexible dry erase panels are each moveably and firmly connected to both the first and second rails, and wherein each of the first plurality of flexible dry erase panels is capable of sliding along the rails.

13. The multi-panel dry erase board of claim 12, wherein each of the plurality of flexible dry erase panels is configured to correspond with one of a week, a day, and a month.

14. The multi-panel dry erase board of claim 12, wherein the first rail, the second rail, and the first plurality of flexible dry erase panels are configured for use in planning worship services.

15. The multi-panel dry erase board of claim 12, wherein the first plurality of flexible dry erase panels are adapted to flex for removal from and insertion into the first and second rails.

16. The multi-panel dry erase board of claim 12, further comprising:
a third rail; and
a second plurality of flexible dry erase panels, wherein the second plurality of flexible dry erase panels are each movably and firmly connected to both the second and third rails.

17. A method for reconfiguring a multi-panel dry erase board, the method comprising:
removing a first flexible dry erase panel from a first location along a first rail and a second rail on the multi-panel dry erase board, wherein removing comprises flexing the first flexible dry erase panel;
repositioning a second flexible dry erase panel into the first location vacated by the first dry erase panel; and
inserting the first dry erase panel in a second location on the multi-panel dry erase board.

18. The method of claim 17, further comprising:
repositioning a third flexible dry erase panel into a location vacated by the second flexible dry erase panel.

19. The method of claim 17, wherein repositioning the second flexible dry erase panel comprises sliding the second flexible dry erase panel along the first and second rails.

20. The method of claim 17, wherein repositioning the second dry erase panel comprises:
removing the second flexible dry erase panel from the first and second rails; and
returning the second flexible dry erase panel to the first and second rails at the first location.
